(19) United States
(12) Patent Application Publication
(10) Pub. No.: US 2010/0163605 A1
(43) Pub. Date: Jul. 1, 2010

(54) BALL IMPLANTATION METHOD AND SYSTEM APPLYING THE METHOD

(75) Inventor: Shiann-Tsong Tsai, Hsinchu (TW)

Correspondence Address: EDWARDS ANGELL PALMER & DODGE LLP, P.O. BOX 55874, BOSTON, MA, 02205, US

(73) Assignee: UNITED TEST CENTER INC., Hsinchu (TW)

(21) Appl. No.: 12/543,919

(22) Filed: Aug. 19, 2009

(30) Foreign Application Priority Data
Dec. 25, 2008 (TW) 097150581

(51) Int. Cl. B23K 1/06

(52) U.S. Cl. 228/179.1; 228/4.1

(57) ABSTRACT

A ball-implantation method and a system applying the method are provided. To begin with, solder balls are implanted onto a flux applied to each of the ball pads on a substrate plate. Then, a vibration force of preset magnitude is exerted on the substrate plate, inducing vibration and causing any solder balls that have deviated from positions corresponding to the ball pads exposed from the openings of a solder mask provided on the substrate plate to return to the correct orientation and be kept therein by the vibration force and gravity. Subsequently, the ball implantation process is completed using a reflow process to solder the implanted solder balls. Using this method and the system thereof, the problem of missing or misaligned solder balls that occurs after the reflow process is solved, thereby dispensing with rework and improving the production yield and product reliability.

### FIELD OF THE INVENTION

The present invention relates to ball implantation methods and systems applying the method, and more specifically, to a method of implanting solder balls onto ball pads on a substrate plate that prevents missing solder balls and a ball implantation system applying the method.

### BACKGROUND OF THE INVENTION

In order to reduce packaging costs and increase production yield, the packaging industry employs a batch substrate plate comprising multiple substrate units in array configuration, on which a molding process is performed after semiconductor chips are attached and electrically connected to respective substrate units on the substrate plate, thus forming encapsulated or molded bodies on the top surface with a semiconductor chips being disposed therein. Then, a ball implantation process is applied using a reflow process to implant solder balls on the bottom surface of the substrate plate. Lastly, a singulation process is performed to form a plurality of discrete semiconductor packages corresponding to the substrate plates.

The batch-type method of forming one or more encapsulants or mold bodies is advantageous in that it allows multiple packages to be fabricated in batches at one time, and thus the molding process need not be repetitively performed on the substrate units, thereby reducing the cost of fabrication. However, due to differences in the coefficient of thermal expansion (CTE) of the materials of the encapsulant, the substrate plate and the semiconductor chip, thermal stresses generated from the temperature cycle in the packaging process easily causes the substrate plate to become warped at places along the longitudinal direction of its two sides, as indicated in FIGS. 1A and 1B, respectively.

Moreover, the size of the substrate plate is preferred to be as large as possible to efficiently increase the production yield by producing as many substrate units as possible on a single substrate plate. However, the bigger the size of a substrate plate, the more serious the warpage problem mentioned above. Since the positions of the flux applicator and ball implantation are fixed, when the substrate plate 12 warps at or along its two longitudinal sides 10a, 10b during the temperature cycle (to become a substrate plate 13), the ball pads 11 situated at the two warped sides 15a, 15b deviate from their intended positions, as depicted by the predetermined ball positions 16a, 16b of FIG. 1B. However, application of flux and implantation of solder balls do not allow changing of positions so as to adjust to the position deviation of the ball pads 11, resulting in positional deviation of a flux 21 applied to the respective ball pads 204 and the solder balls 22 implanted onto the flux 21. That is, the flux 21 and solder balls 22 deviate from the center of the ball pads 204, which in turn prevents the solder balls 22 from being aligning with ball pads 204 and thus securely trapped by the flux 21, eventually causing the problem of missing balls and affecting the yield of process as a result.

Therefore, it is desirable to provide a ball implantation method that prevents the problem of missing balls after the reflow process and yet does not compromise the size of the substrate plate used for this kind of batch-type molding process.

### SUMMARY OF THE INVENTION

In view of the foregoing drawbacks associated with the conventional technology, a primary objective of the present invention is to provide a ball implantation method and a system applying the method that can prevent the problem of missing balls to increase the production yield as a result.

In order to achieve the foregoing and other objectives, the ball implantation method proposed by the present invention comprises the steps of: providing a substrate plate comprised of a plurality of substrate units; applying a flux to a plurality of ball pads exposed from the substrate plate; implanting a plurality of solder balls onto the flux; exerting a vibration force of preset magnitude on the substrate plate to enable any solder balls on any warped portions that have deviated from positions corresponding to ball pads to return to the positions corresponding to the ball pads by the vibration force and gravity; and performing a reflow process to implant the solder balls onto the substrate plate.

In the method of ball implantation, a solder mask is formed on the substrate plate and has a plurality of openings formed therein to expose corresponding solder pads underneath the solder mask therefrom. In the process, the flux is glutinous and does not harden until being processed during the reflow operation. For any implanted solder balls not aligned with corresponding ball pads, a vibration force exerted on the substrate plate in whole enables the solder balls to move within the desired range of the applied flux until the solder balls return to and are kept in the openings thereof, thereby securely trapping the solder balls on their respective ball pads to solve the problem of missing balls after the reflow process.

The vibration force can be produced by any conventional vibration equipment, such as ultrasonic oscillators or mechanical vibrators, provided that the vibration equipment exerts a controllable vibration force on the substrate plate to effectuate the purposes. The vibration force is applied sideward, vertically, or both, but is not limited thereto

The present invention further proposes a ball implantation system applying the method described above, comprising a carrier for carrying the substrate plate comprised by a plurality of substrate units, wherein a solder mask is provided on the substrate plate, the solder mask having a plurality of openings formed therein to expose corresponding ball pads of the substrate therefrom; a flux applicator for applying a flux to each of the solder pads, a solder ball implanter for implanting solder balls onto each respective flux; a vibration force generating unit for exerting a vibration force of preset magnitude on the substrate plate; and a reflow unit for soldering solder balls onto the substrate plate.

Accordingly, the ball implantation method and system proposed by the present invention enable solder balls not coupled to corresponding solder pads to move and return to and be kept in the openings of the solder mask, thereby preventing the problem of missing balls as encountered in the prior art.

### BRIEF DESCRIPTION OF THE DRAWINGS

The present invention can be more fully understood by reading the following detailed description of the preferred embodiments, with reference made to the accompanying drawings, wherein:

FIG. 1A and FIG. 1B are cross-sectional views illustrating warpage on the two longitudinal sides of a substrate plate;

FIGS. 2A through 2E are cross-sectional views illustrating the steps of implementing the method of ball implantation according to the present invention; and

FIGS. 3A through 3E are cross-sectional views illustrating the system of implementing the method of ball implantation according to the present invention.

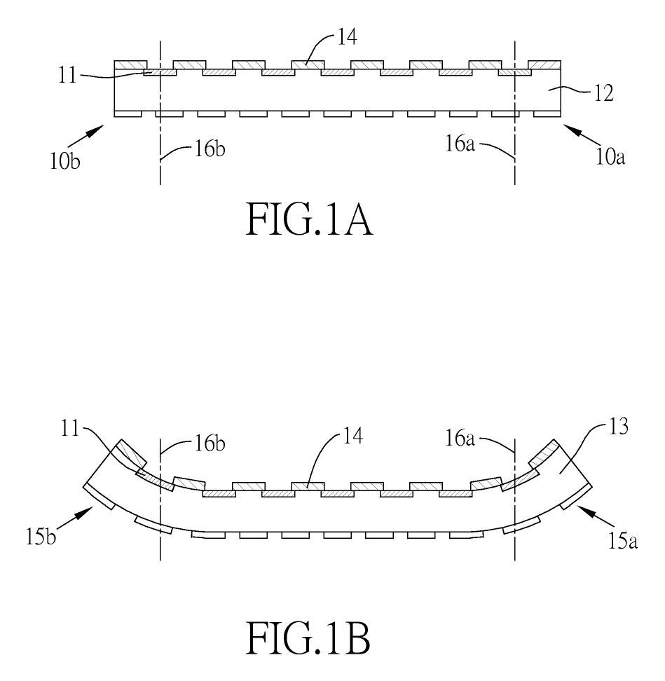

### DETAILED DESCRIPTION OF THE PREFERRED EMBODIMENTS

The present invention is hereunder described with specific embodiments, such that one skilled in the pertinent art can easily understand other advantages and effects of the present invention from the disclosure of the invention. The present invention may also be implemented and applied according to other embodiments, and the details may be modified based on different views and applications without departing from the spirit of the present invention.

The following embodiments describe the ball implantation method and the system applying the method. The drawings are simplified to show the essential features of the present invention in an understandable manner, and only components directly related to the present invention are shown, but details of the remaining components are omitted for brevity.

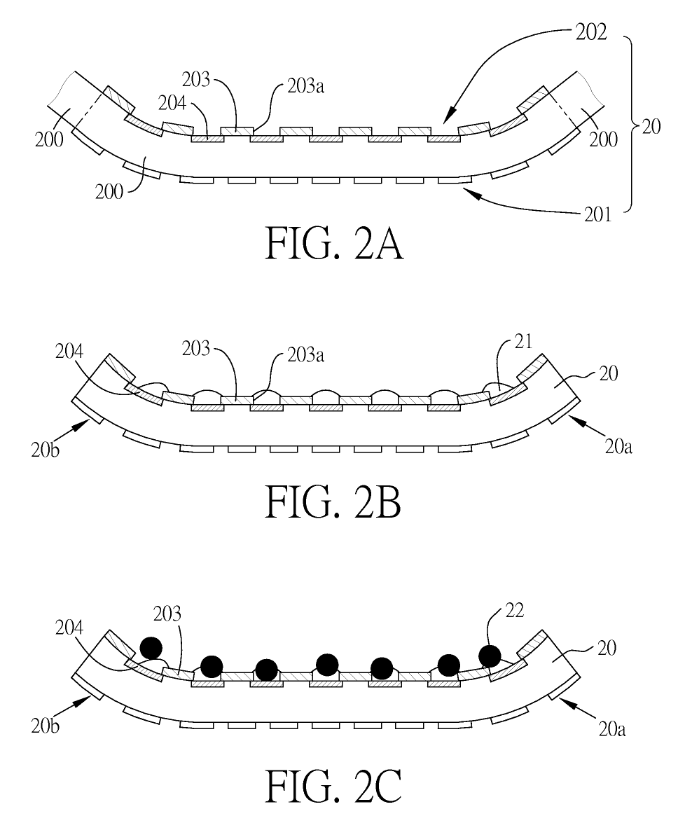

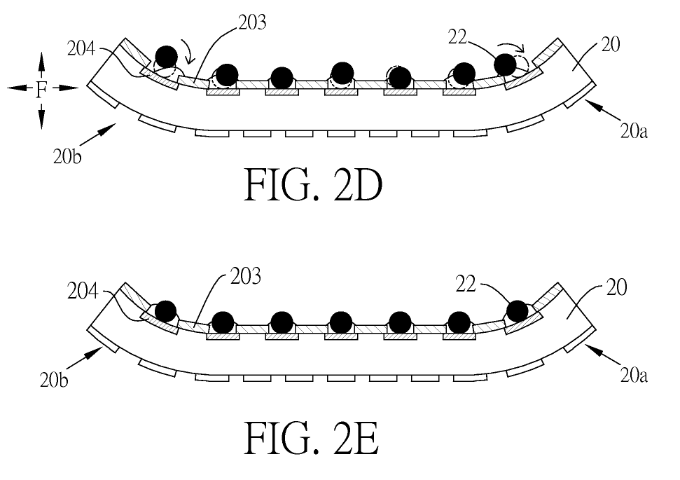

FIGS. 2A through 2E are cross-sectional views illustrating the steps of implementing the method of ball implantation according to the present invention. As shown in FIG. 2A, a substrate plate 20 comprising a plurality of substrate units 200 is provided, the substrate plate 20 having first and second surfaces 201, 202, wherein a chip and an encapsuant enclosing the chip are formed on the exposed surface of each of the substrate units 200. In view of the well-known nature of this process technology, the related processes of mounting chips and forming encapsulants on the substrate units 200 are not specifically depicted herein for brevity. In an embodiment of the ball implantation method, a solder mask 203 is formed on the second surface 202 of the substrate plate 20, and the solder mask 203 has a plurality of openings 203a formed therein to expose each of the ball pads 204 underneath the solder mask 203 therefrom. The substrate plate 20 includes, but is not limited to, common flip-chip substrates, Ball Grid Array (BGA) substrates and Window BGA substrates.

As illustrated in FIG. 2B, a flux 21 is applied to each of the ball pads 204 exposed from the substrate plate 20 by means of a conventional flux applicator (not shown). However, with warpage at the two longitudinal sides of the substrate plate 20 as indicated by the arrows during the temperature cycle, the flux 21 applied by the flux applicator to two longitudinal sides 20a, 20b of the substrate plate 20 deviates from the center of the ball pads 204.

FIG. 2C illustrates implanting a plurality of solder balls onto the flux 21 by a conventional ball implanter (not shown). In that the positions of the flux applicator and ball implantation are predetermined, the flux 21 being applied to the two longitudinal sides 20a, 20b deviates from the intended preset positions and thus causes deviation of ball implantation on both sides where the warpage occurred, thus affecting the positioning of the solder balls 22 on the ball pads 204 exposed from the openings 203a. That is, some of the solder balls 22 are misaligned with respect to the ball pads 204.

Subsequent to the process of ball implantation, as illustrated in FIG. 2D, a vibration force F of preset magnitude is exerted on the substrate plate 20 by, for example, an ultrasonic vibrator to induce vibration of the substrate plate 20 before the flux 21 hardens, thereby enabling solder balls 22 that initially deviated from their respective ball pads 204 to move within the range of the applied flux by the vibration force and then return to the openings 203a of solder mask 203 by gravity, thus limiting and grabbing solder balls 22 therein. The vibration force can be produced by conventional vibration equipment, such as ultrasonic oscillators or mechanical vibrators, provided that the vibration equipment exerts a controllable vibration force on the substrate plate 20 to effectuate the purposes. The vibration force is applied sideward, vertically, or both, but is not limited thereto. It should be noted that the solder balls 22 positioned on the ball pads 204 and arranged along the two longitudinal sides 20a, 20b of the substrate plate 20 are confined to the openings 203a of solder mask 203 and therefore do not roll despite a vibration force exerted on the substrate plate 20. Hence, the vibration force exerted on the substrate plate in whole enables the solder balls to move within the desired range of the applied flux until the solder balls return to and are kept in the openings thereof, thereby securely trapping the solder balls on their respective ball pads.

Lastly, as shown in FIG. 2E, a reflow process is performed on the substrate plate 20 in order to securely solder the implanted solder balls 22 thereon, thereby overcoming the problem of missing balls and improving the production yield and product reliability.

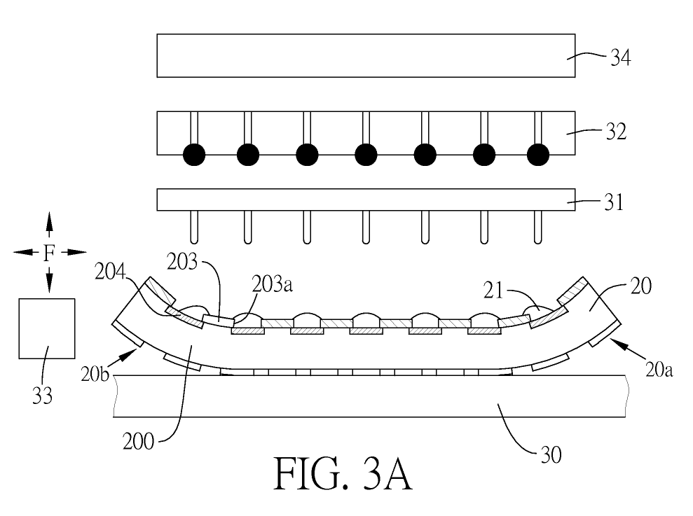

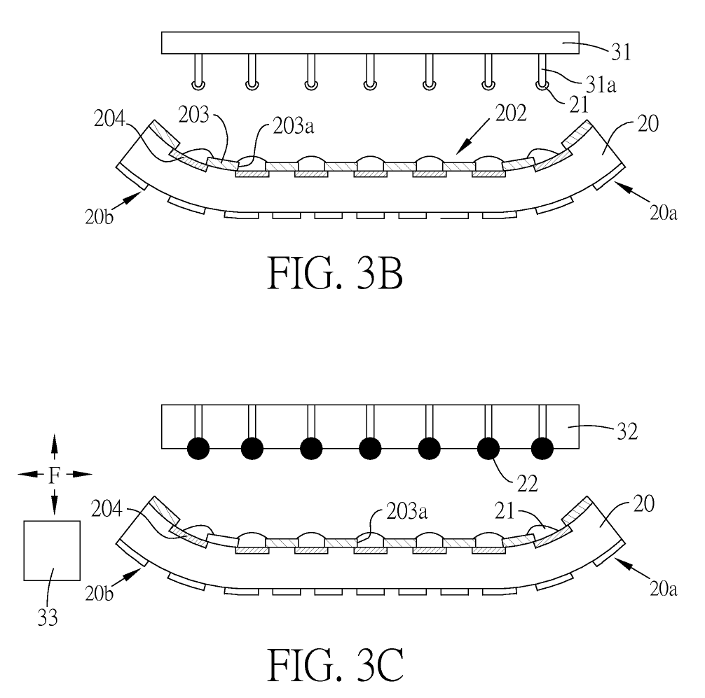

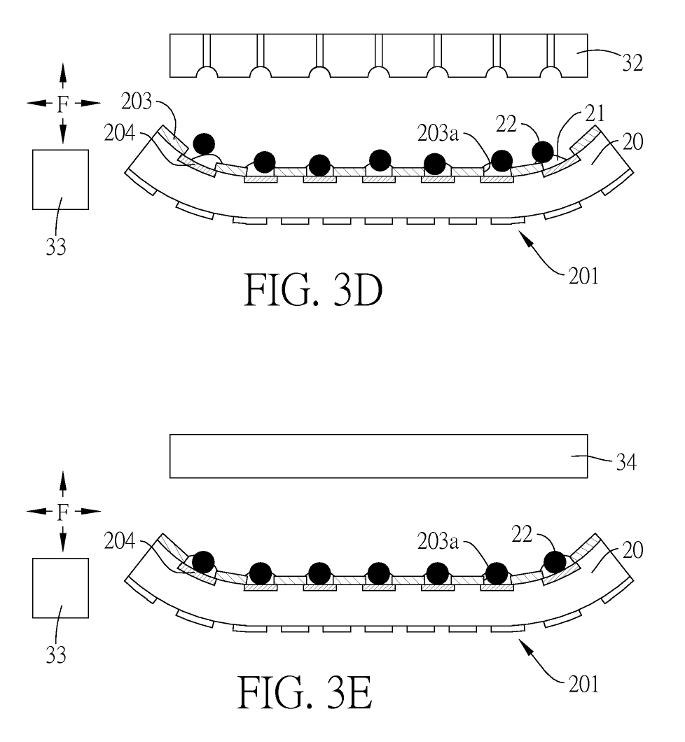

FIGS. 3A through 3E are cross-sectional views illustrating the system of implementing the method of ball implantation according to the present invention.

As depicted in FIG. 3A, the ball implantation system applying the method described above comprises: a carrier 30, a flux applicator 31, a solder ball implanter 32, a vibration force generating unit 33, a reflow unit 34, and a substrate plate 20 comprised of a plurality of substrate units 200 and carried by the carrier 30, wherein a solder mask 203 is formed on the substrate plate 20. The solder mask 203 has a plurality of openings 203a formed therein to expose the ball pads 204 of the substrate plate 20 therefrom. The substrate plate 20 includes, but is not limited to, common flip-chip substrates, Ball Grid Array (BGA) substrates and Window BGA substrates.

As illustrated in FIG. 3B, the flux applicator 31 applies the flux 21, via an output portion 31a, to ball pads 204 exposed from the substrate plate 20. However, with warpage at the two longitudinal sides of the substrate plate 20 during the temperature cycle, the flux 21 applied by the flux applicator 31 to the two sides 20a, 20b of the substrate plate 20 deviates from the center of the ball pads 204. Subsequently, as indicated in FIG. 3C, the solder ball implanter 32 is provided to implant solder balls 22 onto the flux 21 applied to the substrate plate 20. In that the positions of the flux applicator 31 and ball implantation are predetermined, the flux 21 being applied to the two longitudinal sides 20a, 20b of the substrate plate 20 deviates from the intended positions, which in turn causes the positions of ball implantation on both sides where warpage occurred to deviate, thus affecting the positioning of the solder balls 22 on the ball pads 204 exposed from the openings 203a.

Subsequent to the process of ball implantation, as illustrated in FIG. 3D, a vibration force F of preset magnitude is exerted on the substrate plate 20 by means of an ultrasonic vibrator to induce vibration to the substrate plate 20 before the flux 21 hardens, such that the implanted solder balls 22 that deviated from the ball pads 204 can move within the range of the applied flux 21 by the vibration force and then return to the openings 203a of the solder mask 203 by gravity to be limited and secured therein. The vibration force can be produced by conventional vibration equipment, such as ultrasonic oscillators or mechanical vibrators, provided that the vibration equipment exerts a controllable vibration force on the substrate plate 20 to effectuate the purposes. The vibration force is applied sideward, vertically, or both, but is not limited thereto. It should be noted that the solder balls 22 positioned on the ball pads 204 and arranged along the two longitudinal sides 20a, 20b of the substrate plate 20 are confined to the openings 203a of solder mask 203 and therefore do not roll despite a vibration force exerted on the substrate plate 20. Hence, the vibration force exerted on the substrate plate in whole enables the solder balls to move within the desired range of the applied flux until the solder balls return to and are kept in the openings thereof, thereby securely trapping the solder balls on their respective ball pads.

Lastly, as shown in FIG. 3E, a reflow process is performed on the substrate plate 20 in order to securely solder the implanted solder balls 22 thereon to the openings 203a of solder mask 203, thereby overcoming the problem of missing balls and improving production yield and product reliability.

In another embodiment, the vibration force generating unit 33 of the present invention can be concurrently applied together with the ball implanter 32. In yet another embodiment, the vibration force generating unit 33 of the present invention works in conjunction with the reflow unit 34 concurrently.

In summary, the ball implantation method and system proposed by the present invention is characterized by enabling solder balls not aligned with ball pads to move and return to openings of a solder mask so as for the solder balls to be secured in position thereto, thereby preventing the problem of missing balls as encountered in the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A ball-implantation method, comprising the steps of:
providing a substrate plate comprised of a plurality of substrate units, wherein a solder mask is formed on the substrate plate and is formed with a plurality of openings to expose corresponding ball pads of the substrate plate;
applying a flux to each of the ball pads;
implanting a plurality of solder balls onto the flux;
exerting a vibration force of preset magnitude on the substrate plate to enable solder balls on any warped portions of the substrate plate that have deviated from positions corresponding to ball pads to return to the positions corresponding to the solder balls by the vibration force and gravity; and
performing a reflow process to solder the solder balls onto the substrate plate.

2. The method as claimed in claim 1, wherein the substrate plate comprised of the substrate units comprises first and second surfaces.

3. The method as claimed in claim 2, wherein each of the substrate units on the first surface of the substrate plate is mounted with a chip and formed with an encapsulant for encapsulating the chip.

4. The method as claimed in claim 2, wherein a solder mask is formed on the second surface of the substrate plate.

5. The method as claimed in claim 1, wherein the vibration force is applied sideward, vertically, or both.

6. A ball-implantation system, comprising:
a carrier for carrying a substrate plate comprised of a plurality of substrate units, wherein a solder mask is provided on the substrate plate and is formed with a plurality of openings to expose corresponding ball pads of the substrate therefrom;
a flux applicator for applying a flux to each of the solder pads;
a solder ball implanter for implanting the solder balls onto the flux;
a vibration force generating unit for exerting a vibration force of preset magnitude on the substrate plate; and
a reflow unit for soldering the implanted solder balls onto the substrate plate.

7. The system as claimed in claim 6, wherein the vibration force generating unit is one of an ultrasonic oscillator and a mechanical vibrator.

8. The system as claimed in claim 6, wherein the vibration force generating unit works in conjunction with the ball implanter concurrently.

9. The system as claimed in claim 6, wherein the vibration force generating unit works in conjunction with the reflow unit concurrently.

10. The system as claimed in claim 6, wherein the vibration force is applied sideward, vertically, or both.

11. The system as claimed in claim 6, wherein the substrate plate comprises flip-chip substrates, Ball Grid Array substrates and Window BGA substrates.
